(19) United States
(12) Patent Application Publication
(10) Pub. No.: US 2021/0224138 A1
(43) Pub. Date: Jul. 22, 2021

(54) PACKET PROCESSING WITH LOAD IMBALANCE HANDLING

(71) Applicant: VMware, Inc., Palo Alto, CA (US)

(72) Inventor: Yong WANG, San Jose, CA (US)

(73) Assignee: VMware, Inc., Palo Alto, CA (US)

(21) Appl. No.: 16/748,770

(22) Filed: Jan. 21, 2020

(51) Int. Cl. G06F 9/50; G06F 9/54; G06F 1/3206

(52) U.S. Cl. CPC G06F 9/5094; G06F 9/505; G06F 2209/508; G06F 1/3206; G06F 2209/5022; G06F 9/546

(57) ABSTRACT

One example method may comprise receiving multiple ingress packets that are destined for one or more virtualized computing instances; assigning the multiple ingress packets to multiple receive (RX) packet queues; and monitoring load information associated with multiple central processing unit (CPU) cores. The example method may also comprise: in response to detecting a load imbalance among the multiple CPU cores based on the load information, identifying at least one first CPU core that requires additional processing capability; and increasing processing capability of the at least one first CPU core and reducing processing capability of at least one second CPU core from the multiple CPU cores.

### BACKGROUND

Virtualization allows the abstraction and pooling of hardware resources to support virtual machines in a software-defined networking (SDN) environment, such as a software-defined data center (SDDC). For example, through server virtualization, virtual machines running different operating systems may be supported by the same physical machine (also referred to as a “host”). Each virtual machine is generally provisioned with virtual resources to run an operating system and applications. The virtual resources may include central processing unit (CPU) resources, memory resources, storage resources, network resources, etc.

### BRIEF DESCRIPTION OF DRAWINGS

FIG. 1 is a schematic diagram illustrating an example software-defined networking (SDN) environment in which packet processing with load imbalance handling may be performed;

FIG. 2 is a schematic diagram illustrating an example of packet processing with load imbalance handling in an SDN environment;

FIG. 3 is a flowchart of an example process for a computer system to perform packet processing with load imbalance handling in an SDN environment;

FIG. 4 is a schematic diagram illustrating example detailed process for packet processing with load imbalance handling in an SDN environment;

FIG. 5 is a schematic diagram illustrating an example of dynamic adjustment of processing capability during load imbalance handling; and

FIG. 6 is a schematic diagram illustrating an example of packet processing with load imbalance handling at a virtual network interface controller (VNIC).

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used throughout the present disclosure to describe various elements, these elements should not be limited by these terms. These terms are used to distinguish one element from another. For example, a first element may be referred to as a second element, and vice versa.

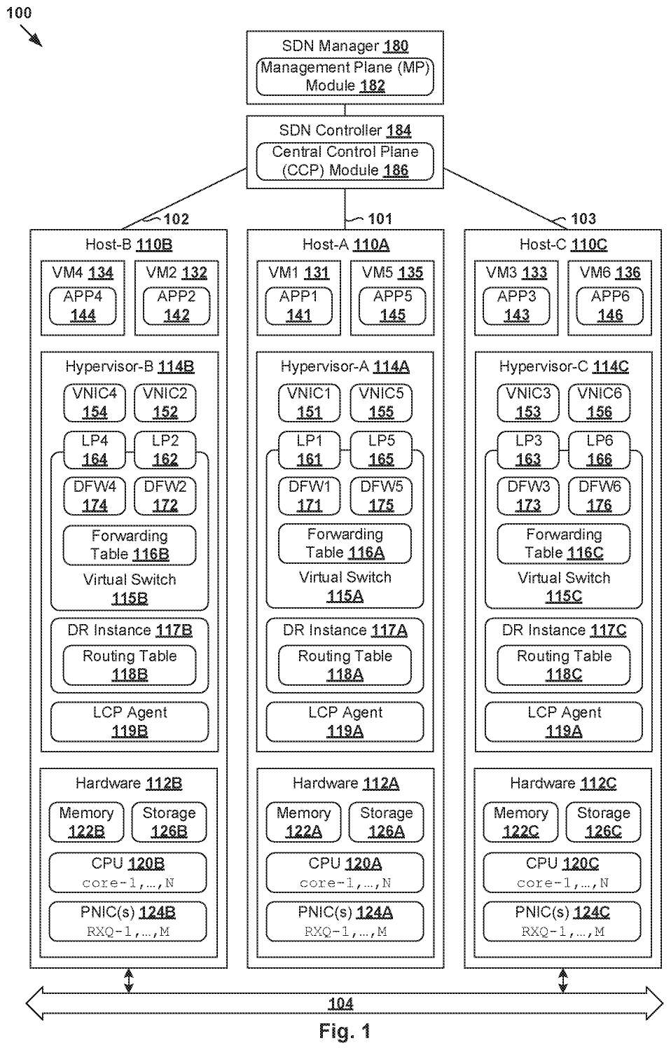

Challenges relating to packet processing will now be explained in more detail using FIG. 1, which is a schematic diagram illustrating example software-defined networking (SDN) environment 100 in which packet processing with load imbalance handling may be performed. Depending on the desired implementation, SDN environment 100 may include additional and/or alternative components than that shown in FIG. 1. SDN environment 100 includes multiple hosts 110A-C that are inter-connected via physical network 104. In practice, SDN environment 100 may include any number of hosts (also known as a “host computers”, “host devices”, “physical servers”, “server systems”, “transport nodes,” etc.), where each host may be supporting tens or hundreds of virtual machines (VMs).

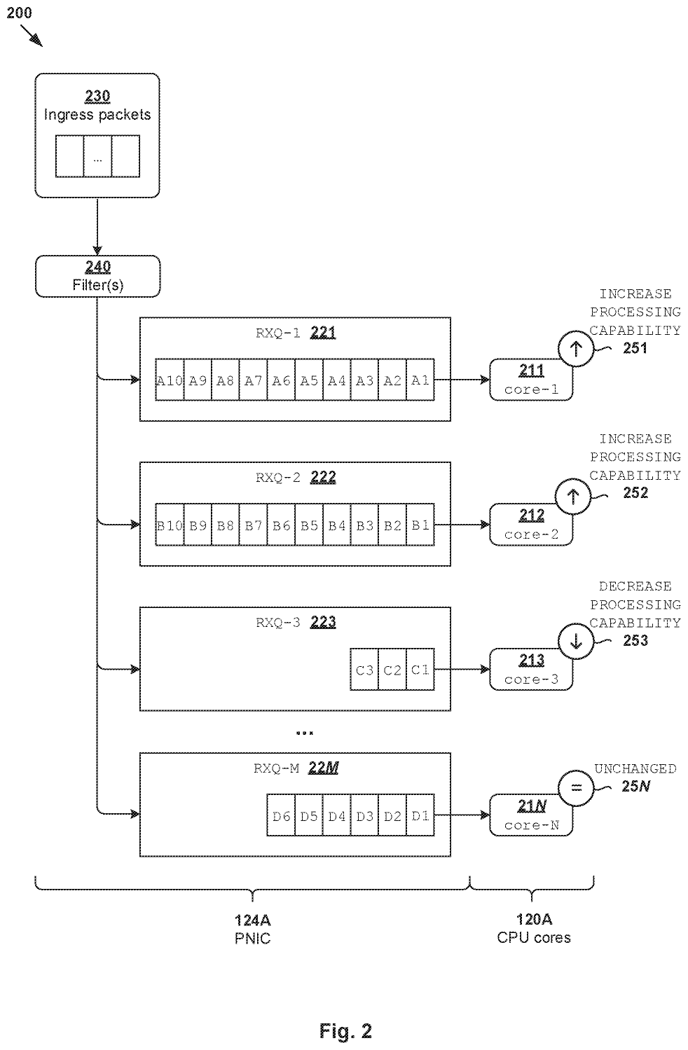

Each host 110A/110B/110C may include suitable hardware 112A/112B/112C and virtualization software (e.g., hypervisor-A 114A, hypervisor-B 114B, hypervisor-C 114C) to support various VMs. For example, hosts 110A-C may support respective VMs 131-136 (see also FIG. 2). Hypervisor 114A/114B/114C maintains a mapping between underlying hardware 112A/112B/112C and virtual resources allocated to respective VMs. Hardware 112A/112B/112C includes suitable physical components, such as central processing unit(s) (CPU(s)) or processor(s) 120A/120B/120C; memory 122A/122B/122C; physical network interface controllers (NICs) 124A/124B/124C; and storage disk(s) 126A/126B/126C, etc.

Virtual resources are allocated to respective VMs 131-136 to support a guest operating system (OS) and application(s). For example, VMs 131-136 support respective applications 141-146 (see “APP1” to “APP6”). The virtual resources may include virtual CPU, guest physical memory, virtual disk, virtual network interface controller (VNIC), etc. Hardware resources may be emulated using virtual machine monitors (VMMs). For example in FIG. 1, VNICs 151-156 are virtual network adapters for VMs 131-136, respectively, and are emulated by corresponding VMMs (not shown for simplicity) instantiated by their respective hypervisor at respective host-A 110A, host-B 110B and host-C 110C. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 114A-C may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” to a network or Internet Protocol (IP) layer; and “layer-4” to a transport layer (e.g., using Transmission Control Protocol (TCP), User Datagram Protocol (UDP), etc.), in the Open System Interconnection (OSI) model, although the concepts described herein may be used with other networking models.

Hypervisor 114A/114B/114C implements virtual switch 115A/115B/115C and logical distributed router (DR) instance 117A/117B/117C to handle egress packets from, and ingress packets to, corresponding VMs. In SDN environment 100, logical switches and logical DRs may be implemented in a distributed manner and can span multiple hosts. For example, logical switches that provide logical layer-2 connectivity, i.e., an overlay network, may be implemented collectively by virtual switches 115A-C and represented internally using forwarding tables 116A-C at respective virtual switches 115A-C. Forwarding tables 116A-C may each include entries that collectively implement the respective logical switches. Further, logical DRs that provide logical layer-3 connectivity may be implemented collectively by DR instances 117A-C and represented internally using routing tables 118A-C at respective DR instances 117A-C. Routing tables 118A-C may each include entries that collectively implement the respective logical DRs.

Packets may be received from, or sent to, each VM via an associated logical port. For example, logical switch ports 161-166 (see “LP1” to “LP6”) are associated with respective VMs 131-136. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 115A-C in FIG. 1, whereas a “virtual switch” may refer generally to a software switch or software implementation of a physical switch. In practice, there is usually a one-to-one mapping between a logical port on a logical switch and a virtual port on virtual switch 115A/115B/115C. However, the mapping may change in some scenarios, such as when the logical port is mapped to a different virtual port on a different virtual switch after migration of a corresponding virtualized computing instance (e.g., when the source host and destination host do not have a distributed virtual switch spanning them).

To protect VMs 131-136 against security threats caused by unwanted packets, hypervisors 114A-C may implement firewall engines to filter packets. For example, distributed firewall (DFW) engines 171-176 (see “DFW1” to “DFW6”) are configured to filter packets to, and from, respective VMs 131-136 according to firewall rules. In practice, network packets may be filtered according to firewall rules at any point along a datapath from a VM to corresponding physical NIC 124A/124B/124C. In one embodiment, a filter component (not shown) is incorporated into each VNIC 151-156 that enforces firewall rules that are associated with the endpoint corresponding to that VNIC and maintained by respective DFW engines 171-176.

Through virtualization of networking services in SDN environment 100, logical networks (also referred to as overlay networks or logical overlay networks) may be provisioned, changed, stored, deleted and restored programmatically without having to reconfigure the underlying physical hardware architecture. A logical network may be formed using any suitable tunneling protocol, such as Virtual eXtensible Local Area Network (VXLAN), Stateless Transport Tunneling (STT), Generic Network Virtualization Encapsulation (GENEVE), etc. For example, VXLAN is a layer-2 overlay scheme on a layer-3 network that uses tunnel encapsulation to extend layer-2 segments across multiple hosts which may reside on different layer 2 physical networks.

SDN manager 180 and SDN controller 184 are example network management entities in SDN environment 100. One example of an SDN controller is the NSX controller component of VMware NSX® (available from VMware, Inc.) that operates on a central control plane. SDN controller 184 may be a member of a controller cluster (not shown for simplicity) that is configurable using SDN manager 180 supporting management plane (MP) module 182. Management entity 180/184 may be implemented using physical machine(s), VM(s), or both. Logical switches, logical routers, and logical overlay networks may be configured using SDN controller 184, SDN manager 180, etc. To send or receive control information, a local control plane (LCP) agent (not shown) on host 110A/110B/110C may interact with central control plane (CCP) module 186 at SDN controller 184 via control-plane channel 101A/101B/101C.

Hosts 110A-C may also maintain data-plane connectivity among themselves via physical network 104 to facilitate communication among VMs located on the same logical overlay network. Hypervisor 114A/114B/114C may implement a virtual tunnel endpoint (VTEP) (not shown) to encapsulate and decapsulate packets with an outer header (also known as a tunnel header) identifying the relevant logical overlay network (e.g., using a VXLAN or “virtual” network identifier (VNI) added to a header field). For example in FIG. 1, hypervisor-A 114A implements a first VTEP associated with (IP address=IP-A, MAC address=MAC-A, VTEP label=VTEP-A), hypervisor-B 114B implements a second VTEP with (IP-B, MAC-B, VTEP-B), hypervisor-C 114C implements a third VTEP with (IP-C, MAC-C, VTEP-C), etc. Encapsulated packets may be sent via an end-to-end, bi-directional communication path (known as a tunnel) between a pair of VTEPs over physical network 104.

Depending on the desired implementation, VM1 131 may be an edge appliance or node capable of performing functionalities of a switch, router, bridge, gateway, any combination thereof, etc. For example, VM1 131 may implement a centralized service router (SR) to provide networking services such as firewall, load balancing, network address translation (NAT), intrusion detection, deep packet inspection, etc. VM1 131 may be deployed to connect one geographical site with an external network and/or a different geographical site.

Conventionally, hosts 110A-C may experience performance issues when there is a large volume of incoming traffic going through PNICs 124A-C and VNICs 151-156. For example, PNICs 124A-C and VNICs 151-156 may rely on network driver technologies such as receive-side scaling (RSS). When RSS is enabled at a NIC (e.g., PNIC or VNIC), ingress packet processing for a packet flow may be shared across multiple CPU cores. However, RSS does not guarantee uniform load distribution among CPU cores, possibly resulting in packet drops due to insufficient CPU cycles. This leads to performance degradation, which is undesirable.

Packet Processing with Load Imbalance Handling

Example packet processing will be explained using FIG. 2, which is a schematic diagram illustrating example 200 of packet processing with load imbalance handling in SDN environment 100. In the following, host-A 110A with CPU cores 120A and PNIC 124A will be used as an example “computer system.” Other hosts 110B-C may implement examples of the present disclosure in a similar manner.

In the example in FIG. 2, CPU 120A may include multiple (N) CPU cores that are denoted as core-1, . . . , core-N (see 211-21N) that are capable of processing ingress packets received via PNIC 124A on host-A 110A. PNIC 124A may support multiple (M) receive (RX) queues that are denoted as RXQ-1, . . . , RXQ-M (see 221-22M). For simplicity, the case of N=M=4 is shown in FIG. 2, where each CPU core is assigned to a different RX queue for packet processing. In practice, however, more than one CPU core may be assigned to one RX queue. Each CPU core may also be mapped to at least one transmit (TX) queue (not shown) to process egress packets.

Ingress packets (see 230) may be destined for various VMs supported by host-A 110A. Using RSS to achieve horizontal scaling, PNIC 124A may assign ingress packets 230 to different RX queues 221-22M to distribute packet processing among CPU cores 211-21N. For example, a filter (see 240) may be applied to each packet to steer that packet towards one of RX queues 221-22M. Any suitable filter 240 may be used, such as by applying a hash function to packet characteristic(s). For example, a packet flow may be identified using its 5-tuple information, including a source IP address, source port number, destination IP address, destination port number and protocol (e.g., TCP). By spreading packet processing load over CPU cores 211-21N, the queue length at RX queues 221-22M may be reduced to improve efficiency.

Further, by assigning packets belonging to one packet flow to the same RX queue, the likelihood of out-of-order TCP packet delivery may be reduced, if not avoided. When the number of packet flow is substantially low, however, RSS hashing may lead to non-uniform load distribution among CPU cores 211-21N. In the example in FIG. 2, there may be a large packet flow (known as “elephant flow”) that is assigned to the same CPU core (e.g., first CPU core 211). This may lead to saturation on one CPU core, but under-utilization on another. In this case, ingress packets may be lost or discarded due to insufficient CPU cycles and/or queue space.

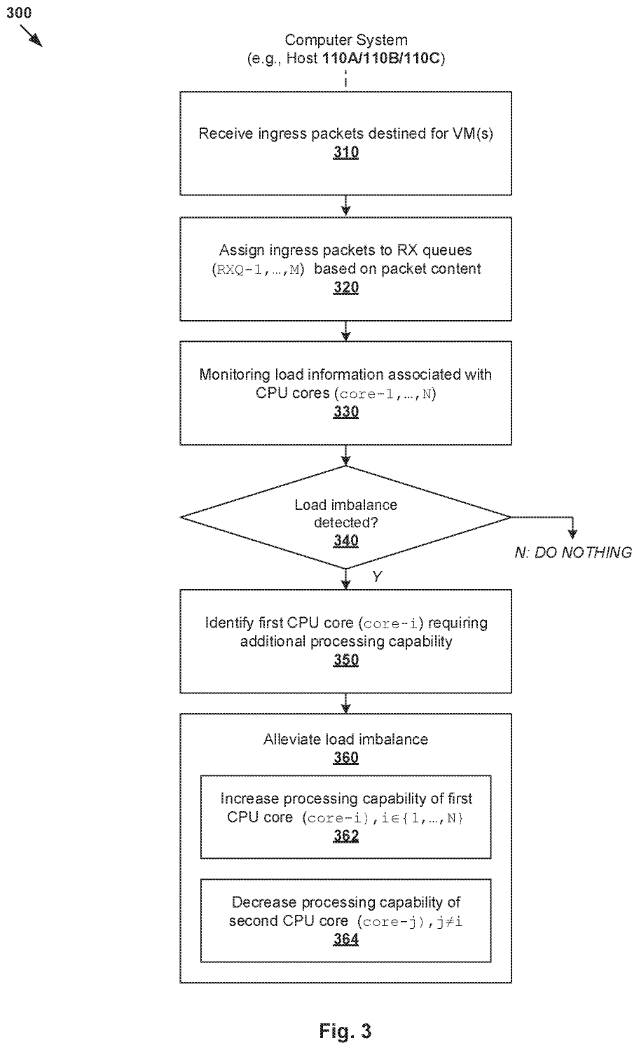

According to examples of the present disclosure, load imbalance handling may be implemented to improve packet processing performance. To mitigate load imbalance, examples of the present disclosure may be implemented to adjusting the processing capability of CPU cores 211-21N in a dynamic, load-aware manner. In more detail, FIG. 3 is a flowchart of example process 300 for a computer system to perform packet processing with load imbalance handling in SDN environment 100. Example process 300 may include one or more operations, functions, or actions illustrated by one or more blocks, such as 310 to 360. The various blocks may be combined into fewer blocks, divided into additional blocks, and/or eliminated depending on the desired implementation.

At 310 and 320 in FIG. 3, in response to receiving ingress packets 230 via PNIC 124A, host 110A may assign ingress packets 230 to RX queues 221-22M based on their content. At 330, host-A 110A may monitor load information associated with CPU cores 211-21N. At 340 and 350, in response to detecting a load imbalance, host-A 110A may identify at least one first CPU core (denoted as core-i, where i ∈{1, . . . , N}) that requires additional processing capability. At 360, load imbalance may be alleviated by (a) increasing processing capability of the at least one first CPU core (core-i) while (b) reducing processing capability of at least one second CPU core (denoted as core-j, where j ∈{1, . . . , N} and j≠i). See also 362 and 364.

For example, at 251-252 in FIG. 2, “first CPU cores” in the form of core-1 211 and core-2 212 may be identified to be over-utilized and require additional processing capability. In this case, to increase processing capability, block 362 may involve activating an increased-capability mode for core-i (i=1, 2) to increase one of the following: operating frequency, voltage, power and thermal budget.

In another example, at 253 in FIG. 2, a “second CPU core” in the form of core-3 213 may be identified to be under-utilized. To reduce processing capability, block 364 may involve activating a power-saving mode for core-3 213 to reduce one of the following: operating frequency, voltage, power and thermal budget. As will be discussed below, processing capability may be increased or reduced in stages. For example, core-3 213 may be configured to operate in an execution power-saving mode (e.g., P-state), and an idle power-saving mode at a later iteration. The processing capability of a CPU core may also be unchanged (see 25N).

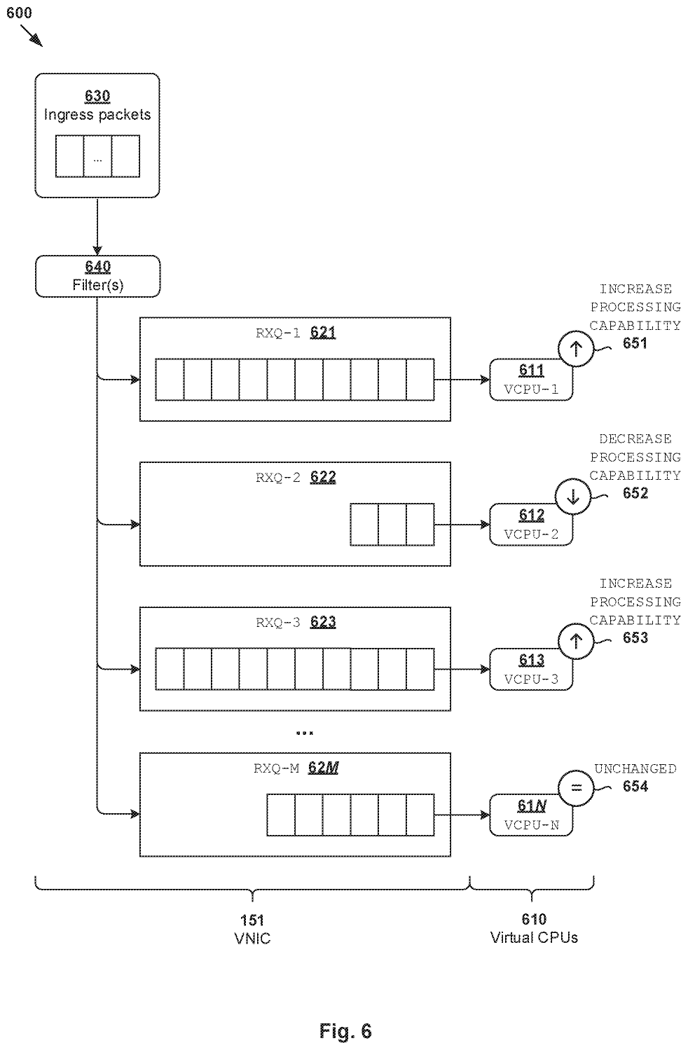

As will be explained further below, examples of the present disclosure may be implemented on PNICs 124A-C (shown in FIG. 2) and VNICs 151-156 (shown in FIG. 6) to, for example, reduce the likelihood of CPU saturation and RX queue overflow on respective hosts 110A-C. As used herein, the term “CPU core” or “processing unit” may be hardware-implemented (e.g., physical CPU cores 211-21N in FIG. 2) or software-implemented (e.g., parallel threads or virtual CPUs to be explained using FIG. 6).

Load Imbalance Detection

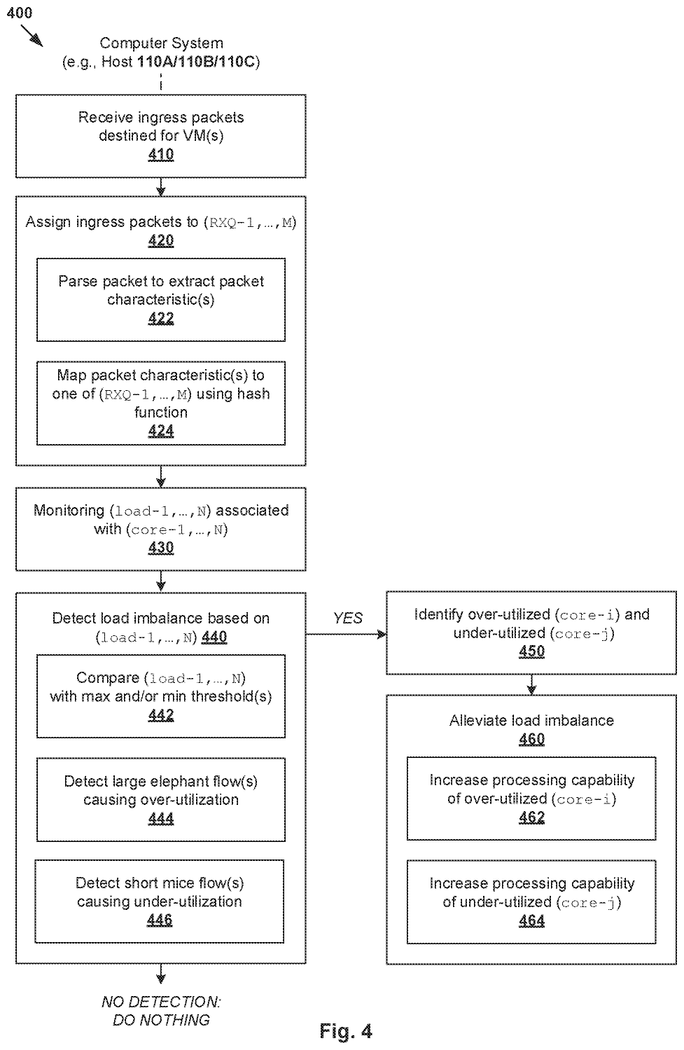

FIG. 4 is a schematic diagram of example detailed process 400 of packet processing with load imbalance handling in SDN environment 100. Example process 400 may include one or more operations, functions, data blocks or actions illustrated at 410 to 464. The various operations, functions or actions may be combined into fewer blocks, divided into additional blocks, and/or eliminated depending on the desired implementation. Example process 400 may be performed by any suitable computer systems, such as host 110A/110B/110C, etc.

(a) Queue Assignment

At 410-420 in FIG. 4, using filter 240, host-A 110A may assign ingress packets 230 received via PNIC 124A to one of RX queues 221-22M. Block 420 may involve parsing each packet to identify content=packet characteristics (see 422) and mapping the packet to one of RX queues 221-22M based on a hash value (see 424). The hash value may be calculated by applying a hash function on any suitable packet characteristic(s). In the example in FIG. 2, a first flow of packets (see “A1” to “A10”) may be assigned to first CPU core 211 (core-1), a second flow (see “B1” to “B10”) to second CPU core 212 (core-2), a third flow (see “C1” to “C3”) to third CPU core 213 (core-3) and a fourth flow (see “D1” to “D6”) to CPU core 21N (core-N).

In practice, the term “content” may refer generally to header information (e.g., inner header and/or outer header), packet payload information, packet metadata, or any combination thereof, etc. Example inner/outer header information may include packet characteristics such as source IP address, source MAC address, source port number, destination IP address, destination MAC address, destination port number, destination port number, protocol, logical overlay network information (e.g., VNI), or any combination thereof, etc. In practice, a packet characteristic may be defined using a range of values, a group that includes a set of distinct values or entities, etc.

(b) Load Imbalance

At 430 in FIG. 4, host-A 110A may monitor load information associated with CPU cores 211-21N. The load information associated with the i^{th} CPU core (core-i) may be denoted as load-i, which may represent CPU utilization information associated with the CPU core. Per-core load (load-i) may be calculated based on the number of packets processed by the CPU core (core-i) within a timeframe, amount of data processed, packet processing operation(s) required, etc. For example, some packets might require decapsulation, decryption and authentication that increases the load, while other packets do not.

In one example, block 430 may involve determining the following: (1) cycles_packet_processing=number of CPU cycles spent on packet processing, (2) count=number of CPU cycles since a last reset, (3) total_cycles=total number of CPU cycles prior to packet processing, and (d) load-i=cycles/(count−total_cycles). These parameters may be determined by reading a time stamp counter (TSC) at different time points of a packet processing loop.

At 440 in FIG. 4, host-A 110A may detect whether there is a load imbalance based on the load information. In practice, the term “load imbalance” may refer generally to a deviation among the utilization or usage of CPU cores, such as when some CPU cores (core-i) are over-utilized while other CPU cores (core j) are under-utilized. At 442, load imbalance detection may involve comparing load information (load-i) with any suitable threshold(s). In a first example, load-i associated with core-i (“first CPU core” in FIG. 3) may be monitored to determine whether it exceeds a maximum threshold (load-i>max_load). In a second example, load-j associated with core-j (“second CPU core” in FIG. 3) may be monitored to determine whether is it is lower than a minimum threshold (load-j<min_load). In a third example, a pair of CPU cores (core-i, core-j) may be monitored to determine whether its load difference exceeds a maximum threshold (load-i−load-j>max_diff).

At 444 in FIG. 4, load imbalance detection may involve detecting elephant flow(s) causing over-utilization at a particular CPU core (core-i). In practice, the term “elephant flow” may refer generally to a substantially large (e.g., in total bytes) packet flow. There are various approaches to detect elephant flow(s) with different assumptions or behavior. For example, an edge appliance (e.g., implemented using VM1 131) may apply a top-k heavy hitter algorithm, such as the Misra-Gries (M-G) algorithm. The algorithm may be used to detect elephant flows whose packet rate or throughput exceeds 1/k of the total throughput on particular CPU core (core-i).

In response to detecting the elephant flow, it is determined whether load information (load-i) of associated CPU core (core-i) is satisfies (e.g., higher than) a predetermined maximum threshold. If yes, core-i may be determined to be over-utilized and would benefit from higher clock rate until the elephant flow is terminated or rescheduled. In one approach, continuity in flow tracking may be supported because a top (elephant) flow detected in one interval might not be a top flow in the next. In this case, as long as the elephant flow is not terminated or rescheduled, it may be assumed that the elephant flow is still active. In another approach, continuity is optional and the decision may be driven by information available in a current time interval. One or both approaches may be implemented for different traffic types to improve CPU utilization.

At 446 in FIG. 4, load imbalance detection may involve detecting mice flow(s) causing under-utilization at a particular CPU core (core-j). In practice, the term “mice flow” or “mouse flow” may refer generally to a substantially short (e.g., in total bytes) packet flow. A mice flow may be detected by monitoring the number of ingress packets, or the amount of data, over a period of time. In response to detecting the mice flow, it is determined whether load information (load-j) of associated CPU core (core-j) satisfies (e.g., lower than) a predetermined minimum threshold.

(c) Dynamic Adjustment of Processing Capability

At 450 and 460 in FIG. 4, host-A 110A may identify and adjust the processing capability of over-utilized CPU core(s) (denoted as core-i), as well as that of under-utilized CPU core(s) (denoted as core-j). The term “processing capability” may be defined using any suitable metric(s), such as frequency, voltage, power, thermal budget, etc. The instantaneous energy usage (power) of the processor a CPU core is related to its activity. If the CPU core is very busy, a lot of gates are required to do a lot of switching.

At 462, for example, increasing processing capability may involve activating an increased-capability mode for the over-utilized CPU core(s) to increase, for example, clock rate (i.e., frequency) and voltage to increase CPU performance. For example, core-i may operate with base frequency=2 GHz prior to load imbalance detection, and an increased frequency=3.x GHz to handle more packets. Additional power and/or thermal budget may also be allocated to core-i that requires extra CPU cycles. Depending on the desired implementation, the processing capability may be increased in stages over time based on real-time packet processing requirements.

At 464, reducing processing capability may involve lowering or limiting the clock rate and/or voltage for under-utilized CPU core(s) that are either idle, waiting or not fully utilized. The processing capability may be reduced in stages. First, core-j may be configured to operate in an execution power-saving mode (known as “P-state”) to reduce processing capability. To further reduce processing capability, core-j may be configured to operate in an idle power-saving mode (known as “C-state”). When in P-state, core-j is still executing instructions relating to packet processing, whereas no execution is performed during C-state.

In practice, any suitable technology may be used to increase processing capability, such as Intel® Turbo Boost 2.0, Intel® Turbo Boost Max Technology 3.0, Intel® Speed Select Technology—Base Frequency (SST-BF) or the like. In the case of 2.0, a deeper P-state may be configured to further reduce the processing capability of core-j such that higher clock rates may be configured for a busier CPU core (core-j). In the case of 3.0, “superior cores” may be identified such that elephant flow(s) may be dispatched to those cores. One approach may involve changing core pinning to switch identified heavy thread(s) to run on superior core(s). Another approach may involve rewriting RSS indirection table to allow PNIC 124A to dispatch elephant flow(s) to superior core(s). In a further approach, hardware queue technology may be used to reschedule elephant flow(s) to superior core(s) after RSS. In the case of SST-BF, asymmetric frequencies may be configured among all cores.

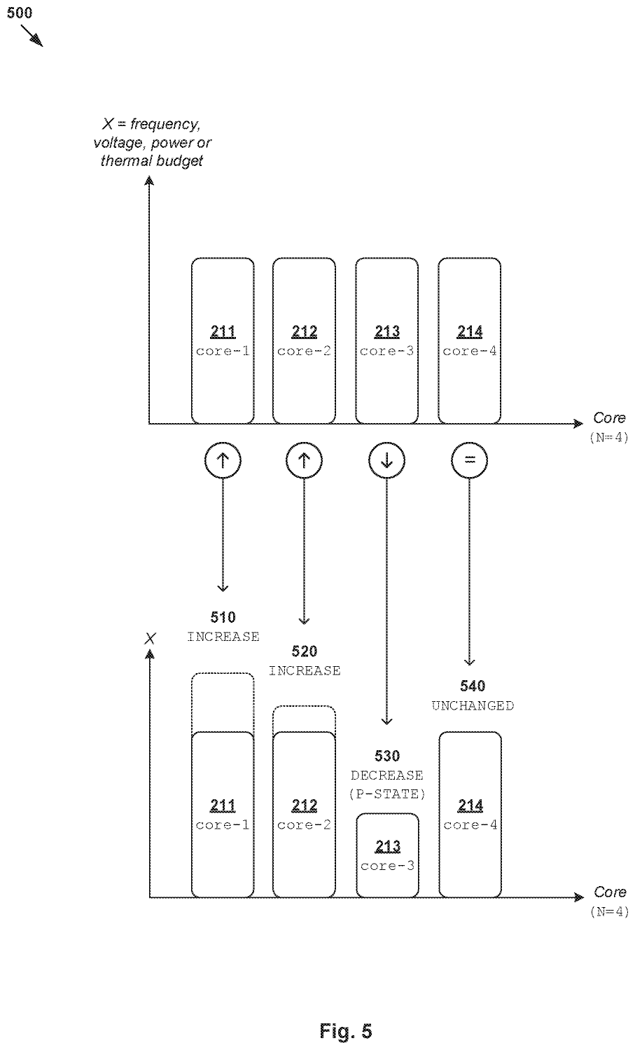

Some examples will be described using FIG. 5, which is a schematic diagram illustrating example 500 of dynamic adjustment of processing capability to facilitate packet processing with load imbalance handling. At 510-520 in FIG. 5, an increased-capability mode may be activated for over-utilized core-i (i=1, 2) based on the example in FIG. 2. The amount of increment may be the same for both CPU cores 211-212, or different (as shown in FIG. 2) based on their processing requirements. At 530, a power-saving mode may be activated for under-utilized core-j (j=3), such as to facilitate clock gating to save power. At 540, the processing capability of core-N (N=4) may be unchanged.

VNIC Implementation

FIG. 6 is a schematic diagram illustrating example 600 of packet processing with load imbalance handling at a VNIC. Similar to FIG. 2, VM1 131 may be allocated with multiple (N) virtual VCPU (VCPU) cores denoted as VCPU-1, . . . , VCPU-N (see 610-61N). VNIC 151 may support multiple (M) receive (RX) queues that are denoted as RXQ-1, . . . , RXQ-M (see 621-62M). Using RSS, VNIC 151 may assign ingress packets 630 destined for VM1 131 to different RX queues 621-62M, thereby distributing processing load among VCPU cores 611-61N. To steer packets towards one of RX queues 621-62M, filter 640 (e.g., hash function based on 5-tuple information) may be applied to each packet.

According to the example in FIG. 3, in response to receiving ingress packets 630 via VNIC 151, ingress packets 630 may be assigned to RX queues 621-62M based on their content (e.g., header and/or payload information). In response to detecting a load imbalance based on load information associated with VCPU cores 611-61N, dynamic adjustment may be performed. At 651/653, the processing capability of over-utilized VCPU-i (i=1, 3) 611/163 may be increased by activating an increased-capability mode. At 652, the processing capability of under-utilized VCPU-j (j=2) 612 may be reduced by operating in an execution or idle power-saving mode. At 654, the processing capability of VCPU-N 61N may be maintained.

To support load imbalance handling inside VM1 131, host-A 110A may expose to VM1 131 the capability of VCPU cores 611-61N in order to leverage it. Once virtualized, the capability of VCPU cores 611-61N is similar to that of physical CPU cores. Other examples discussed using FIGS. 1-5 are also applicable here and will not be repeated here for brevity. For example, detailed process 400 in FIG. 4 may be implemented for queue assignment, load information monitoring, processing capability adjustment, etc. Using examples of the present disclosure, processor power management solutions may be leveraged to mitigate load imbalance caused by hash-based RX dispatching.

Container Implementation

Although explained using VMs 131-136, it should be understood that public cloud environment 100 may include other virtual workloads, such as containers, etc. As used herein, the term “container” (also known as “container instance”) is used generally to describe an application that is encapsulated with all its dependencies (e.g., binaries, libraries, etc.). In the examples in FIG. 1 to FIG. 6, container technologies may be used to run various containers inside respective VMs 131-136. Containers are “OS-less”, meaning that they do not include any OS that could weigh 10s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies. The containers may be executed as isolated processes inside respective VMs.

Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 6. For example, a computer system capable of acting as host 110A/110B/110C may be deployed to perform packet processing with load imbalance handling.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

I claim:

1. A method for a computer system to perform packet processing with load imbalance handling, wherein the method comprises:
receiving multiple ingress packets that are destined for one or more virtualized computing instances supported by the computer system;
based on content of the multiple ingress packets, assigning the multiple ingress packets to multiple receive (RX) packet queues;
monitoring load information associated with multiple central processing unit (CPU) cores, wherein the multiple CPU cores are configured to process the multiple ingress packets in the multiple RX packet queues; and
in response to detecting a load imbalance among the multiple CPU cores based on the load information,
identifying, from the multiple CPU cores, at least one first CPU core that requires additional processing capability; and
increasing processing capability of the at least one first CPU core and reducing processing capability of at least one second CPU core from the multiple CPU cores.

2. The method of claim 1, wherein increasing the processing capability comprises:
activating an increased-capability mode for a particular first CPU core to increase one or more of the following: operating frequency, voltage, power and thermal budget.

3. The method of claim 1, wherein reducing the processing capability comprises:
activating a power-saving mode for a particular second CPU core to reduce one or more of the following: operating frequency, voltage, power and thermal budget.

4. The method of claim 3, wherein reducing the processing capability comprises one of the following:
configuring the particular second CPU core to operate in an execution power-saving mode to decrease processing capability; and
configuring the particular second CPU core to operate in an idle power-saving mode to further decrease processing capability.

5. The method of claim 1, wherein detecting the load imbalance comprises one of the following:
detecting an elephant packet flow that causes over-utilization at a particular first CPU core, wherein the load information associated with the particular first CPU core satisfies a maximum threshold; and
detecting a mice packet flow that causes under-utilization at a particular second CPU core, wherein the load information associated with the particular second CPU core satisfies a minimum threshold.

6. The method of claim 1, wherein monitoring the load information comprises:
monitoring the load information associated with multiple physical CPU cores that are configured to retrieve the multiple ingress packets from at least one physical network interface controller (PNIC) of the computer system.

7. The method of claim 1, wherein monitoring the load information comprises:
monitoring the load information associated with multiple virtual CPU cores that are configured to retrieve the multiple ingress packets from at least one virtual network interface controller (VNIC) of the computer system.

8. A non-transitory computer-readable storage medium that includes a set of instructions which, in response to execution by a processor of a computer system, cause the processor to perform a method of packet processing with load imbalance handling, wherein the method comprises:
receiving multiple ingress packets that are destined for one or more virtualized computing instances supported by the computer system;
based on content of the multiple ingress packets, assigning the multiple ingress packets to multiple receive (RX) packet queues;
monitoring load information associated with multiple central processing unit (CPU) cores, wherein the multiple CPU cores are configured to process the multiple ingress packets in the multiple RX packet queues; and
in response to detecting a load imbalance among the multiple CPU cores based on the load information,
identifying, from the multiple CPU cores, at least one first CPU core that requires additional processing capability; and
increasing processing capability of the at least one first CPU core and reducing processing capability of at least one second CPU core from the multiple CPU cores.

9. The non-transitory computer-readable storage medium of claim 8, wherein increasing the processing capability comprises:
activating an increased-capability mode for a particular first CPU core to increase one or more of the following: operating frequency, voltage, power and thermal budget.

10. The non-transitory computer-readable storage medium of claim 8, wherein reducing the processing capability comprises:
activating a power-saving mode for a particular second CPU core to reduce one or more of the following: operating frequency, voltage, power and thermal budget.

11. The non-transitory computer-readable storage medium of claim 10, wherein reducing the processing capability comprises one of the following:
configuring the particular second CPU core to operate in an execution power-saving mode to decrease processing capability; and
configuring the particular second CPU core to operate in an idle power-saving mode to further decrease processing capability.

12. The non-transitory computer-readable storage medium of claim 8, wherein detecting the load imbalance comprises one of the following:
detecting an elephant packet flow that causes over-utilization at a particular first CPU core, wherein the load information associated with the particular first CPU core satisfies a maximum threshold; and
detecting a mice packet flow that causes under-utilization at a particular second CPU core, wherein the load information associated with the particular second CPU core satisfies a minimum threshold.

13. The non-transitory computer-readable storage medium of claim 8, wherein monitoring the load information comprises:
monitoring the load information associated with multiple physical CPU cores that are configured to retrieve the multiple ingress packets from at least one physical network interface controller (PNIC) of the computer system.

14. The non-transitory computer-readable storage medium of claim 8, wherein monitoring the load information comprises:
monitoring the load information associated with multiple virtual CPU cores that are configured to retrieve the multiple ingress packets from at least one virtual network interface controller (VNIC) of the computer system.

15. A computer system, comprising:
multiple central processing unit (CPU) cores; and
a non-transitory computer-readable medium having stored thereon instructions that, when executed by the processor, cause the processor to:
receive multiple ingress packets that are destined for one or more virtualized computing instances supported;
based on content of the multiple ingress packets, assign the multiple ingress packets to multiple receive (RX) packet queues;
monitor load information associated with multiple central processing unit (CPU) cores, wherein the multiple CPU cores are configured to process the multiple ingress packets in the multiple RX packet queues; and
in response to detecting a load imbalance among the multiple CPU cores based on the load information,
identify, from the multiple CPU cores, at least one first CPU core that requires additional processing capability; and
increase processing capability of the at least one first CPU core and reducing processing capability of at least one second CPU core from the multiple CPU cores.

16. The computer system of claim 15, wherein the instructions for increasing the processing capability cause the processor to:
activate an increased-capability mode for a particular first CPU core to increase one or more of the following: operating frequency, voltage, power and thermal budget.

17. The computer system of claim 15, wherein the instructions for reducing the processing capability cause the processor to:
activate a power-saving mode for a particular second CPU core to reduce one or more of the following: operating frequency, voltage, power and thermal budget.

18. The computer system of claim 18, wherein the instructions for reducing the processing capability cause the processor to one of the following:
configure the particular second CPU core to operate in an execution power-saving mode to decrease processing capability; and
configure the particular second CPU core to operate in an idle power-saving mode to further decrease processing capability.

19. The computer system of claim 15, wherein the instructions for detecting the load imbalance cause the processor to one of the following:
detect an elephant packet flow that causes over-utilization at a particular first CPU core, wherein the load information associated with the particular first CPU core satisfies a maximum threshold; and
detect a mice packet flow that causes under-utilization at a particular second CPU core, wherein the load information associated with the particular second CPU core satisfies a minimum threshold.

20. The computer system of claim 15, wherein the instructions for monitoring the load information cause the processor to:
monitor the load information associated with multiple physical CPU cores that are configured to retrieve the multiple ingress packets from at least one physical network interface controller (PNIC) of the computer system.

21. The computer system of claim 15, wherein the instructions for monitoring the load information cause the processor to:
monitor the load information associated with multiple virtual CPU cores that are configured to retrieve the multiple ingress packets from at least one virtual network interface controller (VNIC) of the computer system.
